(19) United States
(12) Patent Application Publication
(10) Pub. No.: US 2018/0370299 A1
(43) Pub. Date: Dec. 27, 2018

(54) TIRE WITH A PRESSURE REGULATOR AND APPLICABLE WHEEL

(71) Applicant: Cesar Rojo Vidal, Barcelona (ES)

(72) Inventor: Cesar Rojo Vidal, Barcelona (ES)

(21) Appl. No.: 15/848,801

(22) Filed: Dec. 20, 2017

(30) Foreign Application Priority Data
Nov. 23, 2016 (ES) 201631504

(51) Int. Cl. B60C 23/00; B60C 23/04

(52) U.S. Cl. CPC B60C 23/004; B60C 23/0408

(57) ABSTRACT

The present invention relates to a wheel with a pressure regulator and to the applicable rim. The wheel has a tire (4) with a main leak-tight chamber (2) connected to an inflation valve (5) and a rim (3). There is arranged in the rim (3) a tunnel (1) forming a leak-tight chamber with gas under high pressure, connected to the main chamber (2) through a manual or automatic regulating valve (6). The regulating valve (6) and the inflation valve (5) can correspond to a two- or three-position valve. The rim therefore includes a leak-tight tunnel (1) therein, with a valve for filling the tunnel (1) oriented towards the outside (13) of the rim (3) and a regulating valve (6) oriented towards the channel (8) for placement of the tire (4).

### TECHNICAL FIELD

The present invention relates to a wheel the rim of which is capable of storing gas under pressure therein. It therefore offers an auxiliary receptacle for monitoring, regulating and maintaining tire pressure. The present invention also relates to the rim that is applicable to the wheel.

The present invention can be applied in the field of land vehicle manufacture and maintenance.

### STATE OF THE ART

Like many other means of transport, bicycles, motorcycles, cars and other vehicles use tire-mounted wheels. Tires use gas pressure to achieve the stiffness required to withstand the weight of the vehicle and to provide the required traction, while at the same time the tire itself also provides additional damping to the vehicle given the damping properties of the gas contained inside the tire. The major drawback of wheels today is the pressure loss and the inability to replenish this pressure without having to stop the vehicle, which may be dangerous on some roads.

Punctures are one of the most well-known problems. There are currently many repair, patch and rubber insert systems. There are also puncture prevention systems, such as the self-sealing liquid, but none of them prevents some of the gas from leaking out when a puncture occurs, as is the case of the self-sealing liquid, or even all the gas from leaking out in other cases.

On the other hand, even though the tire is in perfect conditions, it loses pressure, so tires require periodic maintenance and they almost never work at the ideal pressure because they constantly lose pressure. The following can be mentioned as examples of the causes of these losses: a small puncture, a tiny hole in the tire, and lack of leak-tightness in the attachment to the rim, even if it is fixed, or when it sustains lateral loads.

To replenish gas pressure inside a tire today, a manual or automatic pump, such as a compressor, for example, is applied. Another option is to provide compressed gas cartridges. Both solutions entail additional weight and more parts, and accordingly a higher cost and complication. Furthermore, this is not always a solution given that, for example, gas cartridges do not always succeed in providing sufficient pressure and more than one has to be used.

In the case of bicycles, given that is a vehicle in which weight is a key factor and the available space is minimized, in some cases they are transported in the cyclist's clothing. This can be dangerous for the cyclist in the event of a fall. In any case, it represents an unwanted addition of weight.

In some professional vehicles, it is possible to regulate pressure while circulating by means of compressors installed in the actual vehicle and complex hydraulic connection systems, sensors, etc. The installation thereof in all vehicles, however, is not possible due to their complexity and cost.

A third problem is when the pressure of the tire has to be modified due to a change in the load of the vehicle or traction requirements.

As a result, the natural state of a tire is the state in which the pressure is lower than that required due to the actual construction thereof. Pressure monitoring systems warn about lower pressure, but they can do nothing to change the pressure of the tire, where this is something that has to be fixed by the user, who can ignore the warning, possibly resulting in at-risk situations.

The following invention seeks to solve the problem of regulating pressure and inflating tires by drastically reducing the number of parts and the complexity of current systems.

### BRIEF DESCRIPTION OF THE INVENTION

The invention consists of a wheel according to the claims.

It relates to a wheel for vehicles, preferably bicycles, motorcycles and automobiles with an improved rim system. This system focuses on eliminating the problem that arises when integrating a system for regulating the pressure of tires or for inflating same, so that the pressure thereof can thus be changed, or so that they can be inflated without requiring external equipment such as manual or automatic pumps, compressors, compressed gas cylinders, to name just some of the available options.

This invention seeks to integrate the element which provides gas pressure to the actual rim by means of a high-pressure gas chamber in the tunnel thereof, and which preferably contains enough air to enable inflating the tire several times over. The tools or elements required to supply pressure to the tires are thereby reduced. The tunnel of the rim is understood to be the hollow structure, which is leak-tight in the case of the invention, inside the rim and shown in FIG. 1, which corresponds to the state of the art.

Being able to regulate pressure in running order makes the vehicle much safer, and in the case of racing vehicles makes them much more competitive because it is not necessary to stop in order to replenish air in the event of a loss since the use of an unsuitable pressure can lead to a puncture. In cycling, car racing and motorcycle racing, the use of self-sealing liquids is very wide-spread today; the major drawback of these liquids, though, is the fact that until the puncture is sealed, a considerable amount of gas is lost from inside the tire, where almost all of the gas contained in the tire may eventually be lost.

Having a high-pressure gas chamber inside the tunnel of the rim, with a valve which automatically regulates, either mechanically or electronically, the pressure in the chamber of the tire means that the performance of the vehicle will not be compromised by the fact that it loses pressure since the system of this invention would be in charge of keeping it constant.

An automatic electronic valve can regulate pressure by means of a controller. This controller may allow the user to regulate the pressure from an on-board computer, an application, etc. This pressure could even be regulated by means of GPS by the user choosing which points require more or less pressure to change vehicle performance. Another possible option is to mount a pressure monitoring sensor, which is widely available on the market; by means of this sensor it is possible to monitor pressure while the user transmits pressure from one chamber to another, controlling the pressure of the chamber of the tire at all times.

The chamber of the tunnel is comprised in the rim, which is a much stiffer element than a tire and allows reaching much higher pressures than the pressures of the main chamber of the tire. Since air or nitrogen is compressible, the gas contained in this chamber may be capable of containing enough air to completely inflate the tire several times over.

In the case of bicycles, this system replaces several widely used elements such as manual pumps which are carried by the cyclists themselves in their jersey, which is an extremely dangerous element in the event of a fall, or they are carried on the actual bicycle, requiring a special holder. Another system that is widely used consists of inflation cartridges, which are cylinders containing liquid CO₂ which, in turn, are also dangerous for cyclists if they are carried in their jersey due to the hardness thereof and due to the risk that they might explode.

An object of the invention is to solve the pressure charging of the main chamber or of the tire of a wheel by means of a pressure regulator. The wheel is of the type which has a tire with a leak-tight main chamber (made of rubber or open in the part facing the rim) connected to an inflation valve, and a rim. Furthermore, and unlike already known wheels, the rim has a tunnel forming a leak-tight chamber which will be filled with gas under high pressure in operating conditions. The chamber of the tunnel is connected to the main chamber through a regulating valve, which can be manual or automatic.

The tunnel will normally take up the entire circumference of the rim, but it may correspond to several independent tunnels, each with its own regulating valve, without departing from the invention. Generally, the singular will be used in the specification to describe different elements, but as is obvious for a person skilled in the art, a different number of these elements may be provided, with the exception of the rim and the tire, in which case there is necessarily only one per wheel.

If the regulating valve is automatic and does not reach the outside of the rim, it is recommendable to create an outer hole in the rim aligned with it to gain access to same and to perform maintenance or to block it. This hole will be suitably sealed by means of any known method to allow the chamber of the tunnel to remain leak-tight while maintenance is not necessary.

If the wheel corresponds to a bicycle and has spokes, said spokes will be attached to the rim preferably by means of respective leak-tight inserts.

The following can be mentioned as automatic regulating valve options:

A mechanical valve, which has a spring that opens the valve when the differential pressure between both chambers is higher than what is stipulated. This spring could be adjusted from the outside.

An electrovalve activated by a pressure sensor, located inside the main chamber. It is possible to include a geolocation system (GPS, for example) to program the pressure of the wheel depending on the position. This solution may be highly recommendable in racing wheels.

To reduce the number of holes in the rim and to simplify maintenance, the regulating valve and the inflation valve may correspond to a single two-position valve or to a three-position valve, which also acts as a valve for filling the chamber of the tunnel.

Vehicle maintenance can be simplified by making the wheel have a pneumatic connection connectable to another wheel. They thereby share their respective chambers of the tunnel and the capacity to fix a punctured tire increases. A single wheel which has been thus modified can also be used to fill all the wheels of the vehicle when it is stopped, which wheels will lack chambers of the tunnel. For example, the connection could be an outlet nozzle to which a tube could be connected or from which the tube is deployed, said tube having a certain length to reach the inflation valves of the other wheels.

Therefore, the rim of the invention comprises a leak-tight tunnel therein, with a valve for filling the tunnel oriented towards the outside of the rim and a regulating valve oriented towards the channel for placement of the tire, where the main chamber thereof will be located.

### DESCRIPTION OF THE DRAWINGS

The following drawings are included to better understand the invention.

FIG. 1 is a partial section of a rim and tire assembly according to the current state of the art.

FIG. 2 is a section view of a rim and tire assembly according to the current state of the art.

FIG. 3 is a side view of a rim and tire assembly according to the current state of the art.

FIG. 4 is a side view of a rim and tire assembly with a possible manner of carrying out this invention, with an additional valve for connecting the chambers.

FIG. 5 is a side section view of a rim and tire assembly with a possible manner of carrying out this invention, with an additional valve for connecting the chambers.

FIG. 6 is a detail section view of the area of the rim and tire in which there is shown a valve capable of adding air pressure on the chamber of the rim.

FIG. 7 is a detail section view of the area of the rim and tire in which there is shown a valve capable of transmitting pressure from the gas chamber of the rim to the chamber of the tire.

FIG. 8 is a detail section view of the area of the rim and tire in which there is shown the connection between the gas chamber of the rim and the gas chamber of the tire.

FIG. 9 is a detail section view of the area of the rim and tire in which there is shown the connection between the outside of the rim and the gas chamber of the tire.

FIG. 10 is a detail section view of the area of the rim and tire in which there is shown the connection between the tunnel of the rim and the gas chamber of the tire.

FIG. 11 is a detail section view of the area of the rim and tire in which there is shown the connection between the tunnel of the rim and the outside of the rim and tire.

FIG. 12 is a side section view of a rim and tire assembly with a possible manner of carrying out this invention without showing any valve.

FIG. 13 is a side section view of a rim and tire assembly with a possible manner of carrying out this invention without showing any valve.

FIG. 14 is a side section view of a rim and tire assembly with a possible manner of carrying out this invention without showing any valve.

FIG. 15 is a side section view of a rim and tire assembly with a possible manner of carrying out this invention without showing any valve.

### EMBODIMENTS OF THE INVENTION

An embodiment of the invention is very briefly described below as an illustrative and non-limiting example thereof.

The invention will be described as being applied to a bicycle or motorcycle wheel, but it can be applied to any other type of wheel with a rim and an air chamber.

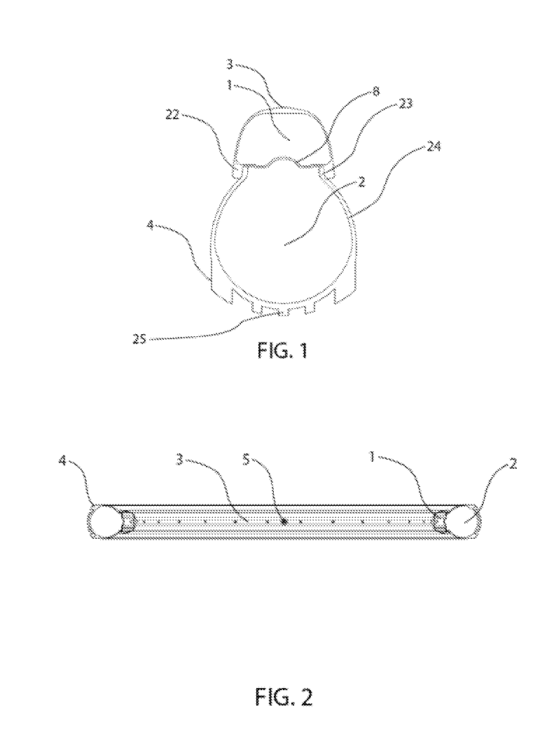

The section of a standard rim and tire assembly for bicycles and motorcycles can be seen in FIG. 1. The following elements are specified in this illustration:

The tunnel (1) of the rim (3) is a characteristic that has been present in bicycle rims for several decades. Its only useful feature up until now has been to confer greater stiffness to the actual rim (3) without increasing the weight with respect to constructions without a tunnel (1).

The rim (3) can be made of several materials, the most common materials being metals, composites, and reinforced plastics, among others. The rim (3) comprises sidewalls (22), which is the portion on which the tire (4), and more specifically the beads (23) of the tire (4), is seated so that it does not pop out of the rim.

The tire (4) comprises a key part known as the main chamber (2) of the tire (4), which contains all the gas providing stiffness and damping for the vehicle, since the sidewalls of the tire (24) are not stiff enough to withstand the weight of the vehicle by themselves. The main chamber (2) of the tire (4) may or may not be sealed at its inner opening by the chamber of the tunnel (1) of the rim (3). In most cases, the main chamber (2) is open towards the chamber of the tunnel (1). In those cases, in order for the air to not leak out of the tire (4) from the inside, a band is used on the channel (8) of the rim (3) so that the gas does not leak out. Said band makes it unnecessary to use a rubber tube inside the main chamber (2), since it seals it against the rim (3) and the outside, where tubeless tires could be used.

The section of the wheel along a certain diameter can be seen in FIG. 2, where the same parts as those discussed above are seen, primarily a tire (4), a rim (3) and both gas chambers, the chamber of the tunnel (1) of the rim (3) and the main chamber (2); the inflation valve (5) of the main chamber of the tire (2) can also be seen. These valves are standard in all vehicles, and generally two types are used, i.e., Presta and Schrader. The fact that they are standard means that they are not the object of this invention and therefore will not be described.

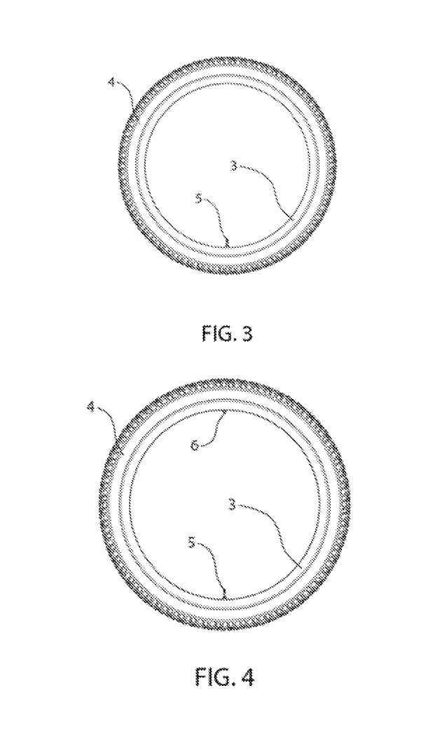

A side view of a conventional rim can be seen in FIG. 3, where the same parts as those discussed above are seen, primarily a tire (4), a rim (3) and the inflation valve (5) of the main chamber of the tire (2).

A side view of a rim according to a first embodiment of this invention can be seen in FIG. 4. The conventional parts making up a wheel can be seen, i.e., the rim (3), the inflation valve (5) of the main chamber (2), the tire (4) and a regulating valve (6) connecting the chamber of the tunnel (1) to the main chamber (2) of the tire, allowing the gas to be communicated between both chambers manually or automatically (for example, electronically or mechanically, when the pressure of the chamber of the tire is lower than a certain value). This regulating valve (6) is in charge of regulating the higher pressure of the chamber of the tunnel (1) and transferring it to the main chamber (2) when needed, such as during a possible puncture, loss of gas of the tire, tire change, or in other situations, for example.

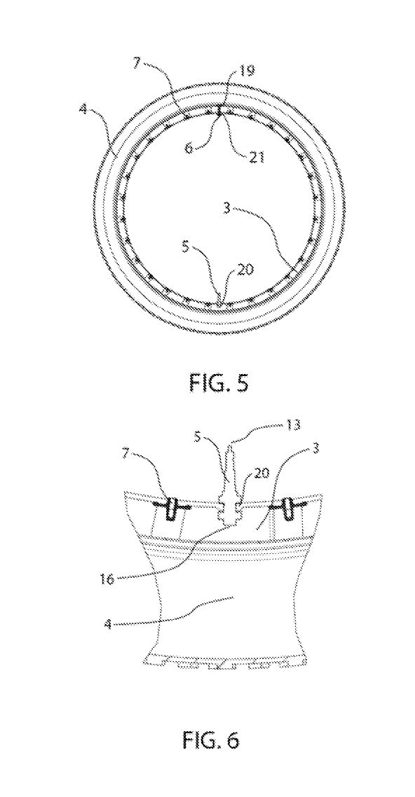

A side section view of a conventional rim with one of the possible options of the system of this invention can be seen in FIG. 5, where the same parts as in FIG. 4 can be seen. In this figure and in FIG. 6, a possible type of insert (7) used for inserting the spokes of the bicycle maintaining the seal of the chamber inside the tunnel (1) is shown. There are other options, such as attaching the spoke to an element adhered externally to the rim (3).

Both chambers, i.e., the tunnel (1) of the rim (3) and the main chamber (2), can also be seen therein. It can be seen in this section how the regulating valve (6) connects both chambers, i.e., the main chamber of the tunnel (1), object of this invention, where gas under high pressure is located, and the main chamber (2), where gas at the tire design pressure suitable for the conditions of the terrain is located. This regulating valve (6) can be manually activated by the user, allowing passage of the gas required to reach the desired pressure in the main chamber (2).

Being able to change the pressure of the main chamber (2) at will is extremely useful for changing the performance of the tire (4), depending on the terrain, and for thereby increasing or reducing friction of the tire (4) with the terrain. The higher the pressure in the main chamber (2), the less contact with the terrain the tread (25) has, and the lower the pressure in the main chamber (2), the more contact with the terrain the tread (25) has, thereby providing more traction to the vehicle. Being able to regulate the pressure in a simple manner therefore greatly improves performance.

In this embodiment, it can be seen how the inflation valve (5) goes through only one inflation hole (20) in the rim (3) to inflate the chamber existing in the tunnel (1), bypassing the main chamber (2). In turn, the regulating valve (6) of this embodiment uses two holes: an outer hole (21) connecting the outside of the rim to the tunnel (1) to enable manually regulating it or to enable modifying the mechanical system, and an inner hole (19) connecting the tunnel (1) of the rim (3) to the main chamber (2) and by means of which the gas is transferred from the high-pressure chamber inside the tunnel (1) to the chamber of the tire (4).

A detail side section view of the area of the aforementioned inflation valve (5) can be seen in FIG. 6. A standard Presta valve has been used for this depiction, though valves of another type, such as Schrader valves, or any other mechanical type, electronic type or others, can be used. The same parts can be seen as in FIG. 4. In this case, it can be seen how the inflation valve (5) connects the outside (13) of the wheel, directly to the chamber of the tunnel (1), instead of directly to the main chamber (2), as is customary. The gas is stored under high pressure in the chamber of the tunnel (1) so that it can be transferred to the main chamber (2) through the regulating valve (6). In this case, the rim (3) has only one through hole communicating with the chamber of the tunnel (1).

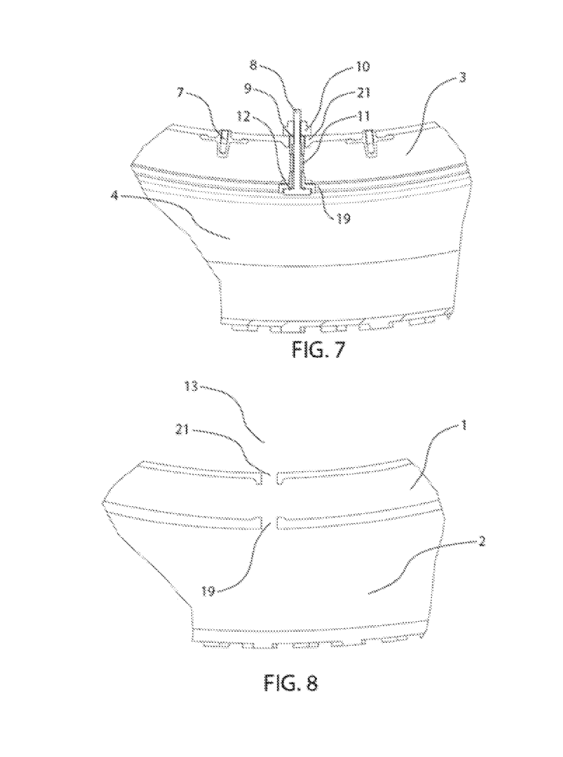

A detail side view of the area of the regulating valve (6) can be seen in FIG. 7, in which how said regulating valve (6) connects both chambers, i.e., the chamber of the tunnel (1) and the main chamber (2), by means of the inner hole (19), is shown. A possible solution of the connection system between both chambers can be seen in this drawing. The proposed mechanism is made up of a structure of the valve (11) which is what acts as a support for the other components of the valve and allows the gas connection between the chamber of the tunnel (1) and the main chamber (2).

A rod (8) that is in charge of opening and closing the regulating valve (6) is provided inside the structure of the valve (11) shown in this drawing. Said rod (8) is screwed onto the structure of the valve (11) to enable carrying out the movement for opening and closing the passage of gas. The gas enters through the structure of the valve (11) and goes through the rim (3) until it reaches the main chamber (2). The rim (3) has an outer hole (21) which is only used in this case to enable manually regulating the pressure between both chambers. In other non-depicted embodiments of this invention, this regulating valve (6) can be automatic, operated by a spring that allows the passage of gas when the differential pressure between both chambers is higher than what is stipulated. This system of the automated regulating valve (6) may be replaced when required with a conventional inflation valve system commonly found in all vehicles using tubeless tires. A closed air chamber could likewise be installed in the tire (4) instead of using a tubeless tire by adapting the regulating and inflation valves, whereby the system is not limited at any time. Another type of manual regulating valve (6) can have two positions separated by rotation corresponding to a certain number of degrees; in one position it is completely closed and in the other it is open. It would act like a gas “cock”. This regulating valve (6) can also be electronically automated. Any automatic regulating valve (6) will allow the user to not worry about the pressure of the tire (4), while it is still necessary for said user to replenish the gas of the tunnel (1) every now and again.

The same view is shown in FIG. 8 as in FIG. 7, but without the assembly of the regulating valve (6) being assembled, such that the inner hole (19) between both chambers and the outer hole (21) between the chamber of the tunnel (1) and the outside (13) can be seen. Since they are aligned, they can be used to remove the regulating valve (6) and install a second inflation valve (14), which must go through the tunnel (1) in a leak-tight manner (FIG. 9), if a temporary replacement is needed due to repair. Versatility of the wheel, which may comprise a conventional tire, is thereby increased. By means of this second inflation valve (14), pressure can be supplied directly to the main chamber (2) from the outside with a standard, manual or automatic, pump-type device or compressor. Said FIG. 9 seeks to show how it is possible to continue using the system the same way these systems are used today.

Even if the regulating valve is automatic and does not require being accessed from the outside, it is nonetheless advisable to provide the outer hole (21) to enable gaining access to a possible blockage of the valve that allows disassembling the tire (4) without losing gas from the chamber of the tunnel (1).

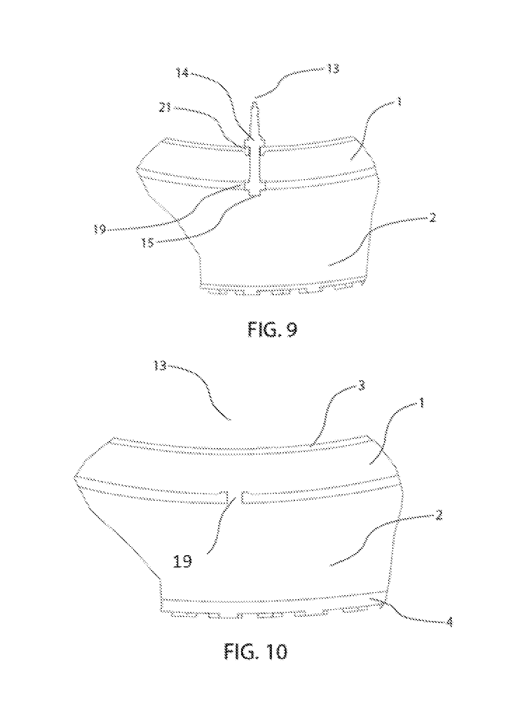

A single inner hole (19), since the outer hole (21) has been eliminated, is shown in FIG. 10. This single inner hole (19) acts as a connection between the chamber of the tunnel (1) and the main chamber (2). A regulating valve (6) for regulating pressure between both chambers, i.e., the chamber of the tunnel (1) and the chamber of the tire (2), is positioned in this single inner hole (19). Since there is no outer hole (21), the regulating valve must be automatic and be controlled from inside the rim (3) or tire (4). It could likewise be actuated remotely from a control of the vehicle, for which purpose it may require a signal receiver (ideally a wireless transceiver).

The same section of the rim and tire is shown in FIG. 11 as in FIG. 6, but in this case no inflation valve (5) is assembled so that the system may be properly seen. The inflation hole (20) connecting the outside (13) of the tire (4) and rim (3) with the chamber of the tunnel (1) can be seen in this section. This inflation hole (20) is used to assemble the inflation valve (5) by means of which the gas under high pressure is blown into the chamber of the tunnel (1), which is later used to always maintain the correct pressure in the main chamber (2).

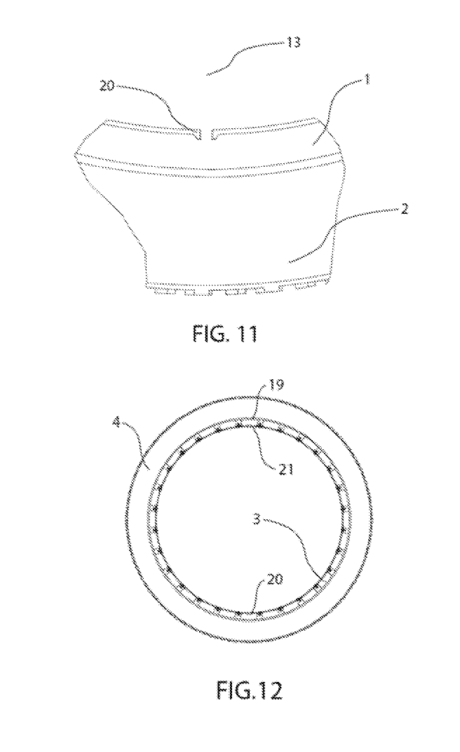

A central section of the rim (3) and tire (4) like in FIG. 5 is shown in FIG. 12, where one of the embodiments of this invention can be seen in which the rim has a total of three holes (19, 20 and 21). Several possibilities, all of which are non-limiting, are contemplated for this manner of carrying out the invention with three holes. One of the possible manners of carrying out this invention uses a valve in the inflation hole (20) to supply pressure to the chamber of the tunnel (1). A regulating valve (6) transmitting gas pressure from the high-pressure chamber (1) to the chamber of the tire (2) manually or by means of an automated system is assembled in the inner hole (19) and outer hole (21), where said automated system could be a mechanical or electronic type system.

The manual system may consist of a simple shutoff cock which allows or blocks gas circulation between the two chambers; since the main chamber (2) has a lower pressure than the chamber of the tunnel (1) does, the gas would only circulate in one direction. The mechanically automated regulating valve (6) may consist of a ball valve with a spring such that when the pressure in the main chamber (2) is less than a value “X”, the spring gives way, allowing air to pass into the main chamber (2). Finally, if it is electronically automated, it would correspond to an electrovalve that regulates pressure in the main chamber (2) by means of a pressure sensor, so every time the pressure is less than a given value, it allows more gas in. By means of this electronic valve and given that access to the outside is gained by means of the outer hole (21), it would also be possible to reduce pressure in the main chamber (2) should that be required.

A standard valve may optionally also be assembled in the inner hole (19) and outer hole (21) to assemble a tube, or a tubeless tire may simply be used, thereby dispensing with the high-pressure chamber (1) should this be required. So the inflation valve (5) assembled in the inflation hole (20) would not have to be used in this case and could be disabled.

It is also possible to assemble in the inner hole (19) and outer hole (21) a two-way valve performing the functions of the inflation valve (5) and regulating valve (6), so the pressure of the main chamber (2) can be manually regulated from the outside by means of a pressure gauge, pump, compressor, or simply by communicating the two chambers, i.e., the chamber inside the tunnel (1) and the chamber of the tire (2), to one another when more pressure is to be supplied to the main chamber (2).

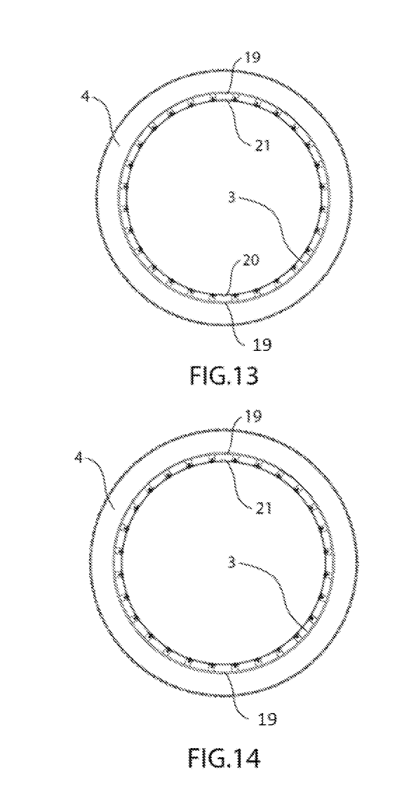

A central section of the rim (3) and tire (4) assembly like in FIG. 5 is shown in FIG. 13. One of the manners of carrying out this invention can be seen therein, where the rim has a total of four holes. Several non-limiting possibilities are contemplated for this manner of carrying out the invention with four holes. One of the possible manners of carrying out this invention uses a two-position valve going through the inflation hole (20) and an inner hole (19) to enable changing the pressure of the main chamber (2) of the tire (4) independently of the chamber of the tunnel (1). Due to the two-position system of this valve, access may be gained to either of the two chambers and pressure thereof may be regulated in a completely independent manner. A regulating valve (6) which would pass air pressure from the high-pressure chamber (1) to the chamber of the tire (2) manually or by means of an automated system can be assembled in the other pair of holes (inner hole (19) and outer hole (21)), where as mentioned above said automated system could be a mechanical or electronic type system. The outer hole (21) is required to enable manually opening or closing this valve connecting the chamber of the tunnel (1) to the main chamber (2). In turn, this outer hole (21) allows the system of the regulating valve (6) for regulating pressure between chambers to be blocked from the outside (13) to enable disassembling the tire (4) and not losing all the gas pressure from the chamber inside the rim (1).

A central section of the rim (3) and tire (4) assembly like in FIG. 5 is shown in FIG. 14, in which one of the preferred manners of carrying out this invention is shown. There is assembled in the inner hole (19) and the outer hole (21) a two-position valve that can be used to choose whether to add gas pressure in the chamber of the tunnel (1) or in the main chamber (2). It is therefore also possible to decrease pressure of the main chamber (2) if desired. Valves of this type are known on the market, so they will not be described as they are not an object of the invention. A single inner hole (19) can be seen in the lower part, where a regulating valve (6) connecting the tunnel (1) to the main chamber (2) will be assembled, so having an outer hole (21) in this area of the rim is avoided and there is a gain in strength. This regulating valve (6) provided for the single inner hole (19) has an either manually or electronically automated operation. If it is a manual valve, by disassembling the tire (4) it is possible to calibrate the valve to change the pressure of passing from the high-pressure chamber, which is the chamber of the tunnel (1), to the lower-pressure chamber, which is the chamber of the tire (2).

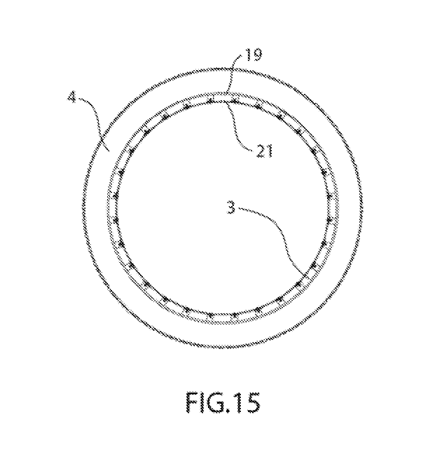

A central section of the rim (3) and tire (4) assembly like in FIG. 5 is shown in FIG. 15, in which one of the manners of carrying out this invention is shown. This manner of carrying out the invention has only two holes, like a conventional rim. The chamber of the tunnel (1) is still leak-tight. A three-position valve acting like an inflation valve (5), a regulating valve (6) and a valve for filling the tunnel (1) is assembled in the inner hole (19) and in the outer hole (21). It is therefore possible to independently increase pressure in the chamber of the tunnel (1) and in the main chamber (2), and at the same time due to this third position one chamber can also be communicated with the other, so an air exchange between chambers is possible.

1. A wheel with a pressure regulator comprising:
a tire (4) having a leak-tight chamber of the tire (4) connected to an inflation valve (5); and
a rim (3);
wherein the rim (3) has a tunnel (1) forming a leak-tight chamber with gas under high pressure, connected to the chamber of the tire (4) through a regulating valve (6).

2. The wheel according to claim 1 having an outer hole (21) connecting the outside (13) of the rim (3) to the tunnel (1) aligned with the regulating valve (6).

3. The wheel according to claim 1 having a series of spokes attached to the rim through a leak-tight insert (7).

4. The wheel according to claim 1, wherein the regulating valve (6) is manual.

5. The wheel according to claim 1, wherein the chamber of the tunnel (1) has a sufficient capacity to store the amount of gas necessary to fill the chamber of the tire several times over.

6. The wheel according to claim 1, wherein the regulating valve (6) is automatic.

7. The wheel according to claim 6, wherein the regulating valve (6) has a spring that opens the valve when the differential pressure between both chambers is higher than what is stipulated.

8. The wheel according to claim 6, wherein the regulating valve (6) is an electrovalve activated by a pressure sensor inside the main chamber.

9. The wheel according to claim 1, wherein the regulating valve (6) and the inflation valve (5) correspond to a single two-position valve.

10. The wheel according to claim 1, having a three-position valve acting as an inflation valve (5), a regulating valve (6), and a valve for filling the chamber of the tunnel (1).

11. The wheel according to claim 1, further comprising a pneumatic connection connectable to another wheel.

12. The wheel according to claim 6, further comprising a geolocation system that activates the regulating valve (6) according to the position of the wheel.

13. The wheel according to claim 6, wherein the regulating valve (6) comprises a wireless signal receiver.

14. The wheel according to claim 1, wherein the chamber of the tire (4) is a main chamber (2) of a tubeless tire (4).

15. A rim for the wheel according to claim 1, further comprising a leak-tight tunnel (1) therein, with a valve for filling the tunnel (1) oriented towards the outside (13) of the rim (3) and a regulating valve (6) oriented towards the channel (8) for placement of the tire (4).
